(19) United States
(12) Patent Application Publication
(10) Pub. No.: US 2014/0235097 A1
(43) Pub. Date: Aug. 21, 2014

(54) APPARATUS AND METHOD FOR ENERGY CONSERVATION

(71) Applicant: Helene M. Webman, Phoenix, AZ (US)

(72) Inventor: Helene M. Webman, Phoenix, AZ (US)

(21) Appl. No.: 13/769,747

(22) Filed: Feb. 18, 2013

(51) Int. Cl. H01R 13/46; H01R 43/26

(52) U.S. Cl. CPC H01R 13/46; H01R 43/26
USPC 439/536; 29/622

(57) ABSTRACT

The most preferred embodiments of the present invention comprise an apparatus that allows any electrical device with an electrical plug to be quickly and efficiently engaged to or disengaged from a power source, while the apparatus remains anchored to the electrical wall outlet, solving the problem of inefficient use of electrical power, clutter and the inconvenience associated with typical electrical devices. A method for using the apparatus is also disclosed.

### RELATED APPLICATION

This application claims the filing date and priority of U.S. Provisional Patent Application Ser. No. 61/600,611, which application was filed on Feb. 18, 2012, and which application is incorporated herein by reference.

### BACKGROUND OF THE INVENTION

1. Technical Field

The present invention relates generally to electricity and more specifically relates to conservation of electrical energy via mechanical devices.

2. Background Art

“Vampire power” or “phantom load” is a well-known electrical phenomenon that occurs when an electrical device is plugged into a power source (e.g., wall outlet) while remaining in standby mode. Even though the electrical device is powered off, the electrical device continues to draw small amounts of electricity to power certain internal components. While the amount of power being consumed is relatively modest, the sheer number of electrical devices currently in use adds up to a more substantial waste of energy.

Additionally, with the widespread adoption of electronic devices and gadgets throughout the world, the amount of electrical power siphoned off by phantom loads is increasing at a rapid rate. While it is possible to address the problem by simply unplugging the electrical device from the power source when not in use, the constant unplugging and plugging back in for each electrical device is a time-consuming and inconvenient chore for most people. Given the relatively small cost to keep the electrical devices plugged in, most people will not unplug their inactive electrical devices on a regular basis.

Accordingly, without improvements in the methods and systems used to combat phantom load, the inefficient consumption of electricity will continue to grow and efforts to reduce wasted electricity will continue to be sub-optimal.

### SUMMARY OF THE INVENTION

The most preferred embodiments of the present invention comprise an apparatus that allows any electrical device with an electrical plug to be quickly and efficiently engaged to or disengaged from a power source, while the apparatus remains anchored to the electrical wall outlet, solving the problem of inefficient use of electrical power, clutter and the inconvenience associated with typical electrical devices. A method for using the apparatus is also disclosed.

### BRIEF DESCRIPTION OF THE DRAWINGS

The preferred embodiments of the present invention will hereinafter be described in conjunction with the appended drawings, wherein like designations denote like elements, and:

FIG. 1 is a front view of a standard wall outlet suitable for use in accordance with a preferred embodiment of the present invention;

FIG. 2 is an side view of an apparatus for energy conservation in an engaged position in accordance with a preferred embodiment of the present invention;

FIG. 3 is an side view of an apparatus for energy conservation in a disengaged position in accordance with a preferred embodiment of the present invention;

FIG. 4 is an side view of an apparatus for energy conservation in an engaged position accordance with an alternative preferred embodiment of the present invention;

FIG. 5 is an side view of an apparatus for energy conservation in a disengaged position in accordance with an alternative preferred embodiment of the present invention;

FIG. 6 is an side view of an apparatus for energy conservation in an engaged position accordance with an alternative preferred embodiment of the present invention;

FIG. 7 is an side view of an apparatus for energy conservation in a disengaged position in accordance with an alternative preferred embodiment of the present invention;

FIG. 8 is a perspective view of the deployment of an apparatus for energy conservation in an engaged position in accordance with an alternative preferred embodiment of the present invention;

FIG. 9 is a perspective view of an apparatus for energy conservation in a disengaged position in accordance with an alternative preferred embodiment of the present invention;

FIG. 9A is a perspective view of an apparatus for energy conservation in an engaged position in accordance with an alternative preferred embodiment of the present invention;

FIG. 10 is a side view of an apparatus for energy conservation in a disengaged position in accordance with an alternative preferred embodiment of the present invention;

FIG. 11 is a side view of an apparatus for energy conservation in an engaged position in accordance with an alternative preferred embodiment of the present invention;

FIG. 12 is a side view of an alternative preferred embodiment of the present invention;

FIG. 13 is a side view of an alternative preferred embodiment of the present invention; and

FIG. 14 is a flow chart of a method for using an apparatus for energy conservation in accordance with a preferred embodiment of the present invention.

### DETAILED DESCRIPTION OF THE INVENTION

The most preferred embodiments of the present invention comprise an apparatus that allows any electrical device with an electrical plug to be quickly and efficiently engaged to or disengaged from a power source, while the apparatus remains anchored to the electrical wall outlet, solving the problem of inefficient use of electrical power, clutter and the inconvenience associated with typical electrical devices. A method for using the apparatus is also disclosed.

The apparatus described herein allows the user to reduce electricity consumption by providing for a way to easily unplug an electrical device from the power source when not in use, while still keeping a charger or electric plug anchored to or positioned near the electrical outlet. With a simple pull, the apparatus allows the user to disengage a charger/plug from the power source but still holds it anchored to the electrical outlet, ready to be easily engaged (re-inserted) once the user needs to recharge/reconnect again.

This provides an efficient way to reduce or eliminate the flow of current from the electrical outlet that is connecting to the electrical or electronic device when the device is not in operation. Additionally, the electrical disconnection of the electrical device from the outlet reduces or eliminates the hazards associated with accidently electrical fires and short circuits that may occur from devices that are left connected to an electrical outlet for extended periods of time. Further, the use of the various embodiments of the present invention provides for electrical cord management since the electrical cord can be held in place and positioned near the electrical outlet even when electrically disconnected from the electrical outlet.

While there are several embodiments of the present invention, the most preferred embodiment of the present invention comprises a housing that is configured to receive an electrical plug for an electrical device. The housing can be quickly and easily attached to and fixed in position in a standard wall outlet. The housing comprises a support pin that made from a nonconductive material (e.g., plastic, nylon or rubber). The support pin is removably inserted into the ground hole of a standard wall outlet, fixing the housing and keeping the housing connected to the electrical outlet until the user removes the housing from the electrical outlet.

With the various preferred embodiments of the present invention, the user can place a charging device or an electrical plug into the housing and selectively engage or disengage the plug from the power source while still keeping the plug enclosed within the housing and keeping it anchored in or near the electrical outlet. When the electrical plug is moved to a first position with in the housing, the conductive blades of the plug will be engaged with the electric circuit contained within the electrical outlet and the electrical device connected to the electrical plug will receive electricity from the power source. When the electrical plug is moved to a second position within the housing, the conductive blades of the electrical plug will be disconnected from the power source and the electrical device connected to the electrical plug will no longer receive electricity from the electric circuit contained within the electrical outlet.

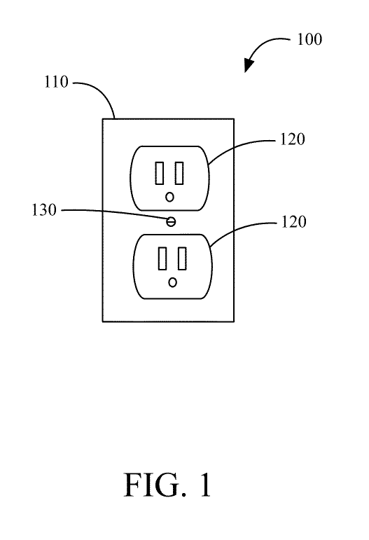

Referring now to FIG. 1 is a front view of a standard wall outlet 100 suitable for use in accordance with a preferred embodiment of the present invention is depicted. As shown in FIG. 1, wall outlet 100 comprises a cover 110, a pair of plug receptacles 120, and a screw 130. Screw 130 is inserted into and through a hole in cover 110 and the threads of screw 130 engage a fixture in the wall. When screw 130 is tightened, cover 110 is fixed in position while leaving plug receptacles exposed for use.

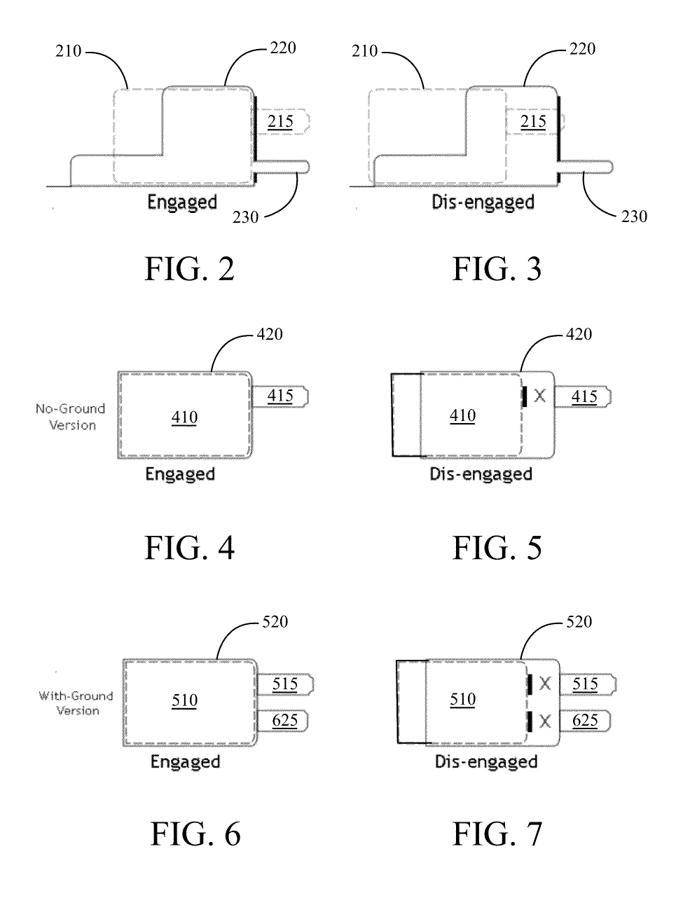

Referring now to FIG. 2, a side view of an apparatus for energy conservation in an engaged position in accordance with a preferred embodiment of the present invention is depicted. As shown in FIG. 2, a housing 220 is used in conjunction with a plug 210. Plug 210 comprises a pair of electrically conductive blades 215. Support pin 230 is a non-conductive element that is sized to fit snugly into the ground hole of a standard wall outlet such as wall outlet 100 of FIG. 1. Support pin 230 provides a means for attaching housing 220 to wall outlet 100. FIG. 2 shows plug 210 in a first position, with blades 215 extending beyond housing 220, allowing blades 215 to engage the electrical circuit housed within wall outlet 100, thereby energizing whatever electrical device is connected to plug 210.

Referring now to FIG. 3, a side view of an apparatus for energy conservation in a disengaged position in accordance with a preferred embodiment of the present invention. As shown in FIG. 3, plug 210 has now been moved to a second position within housing 220. In the second position, blades 215 are no longer engaged with the electrical circuit housed within wall outlet 100 of FIG. 1, thereby de-energizing whatever electrical device is connected to plug 210.

It should be noted that FIG. 2 and FIG. 3 represent an embodiment of the present invention that is useful for any type of electrical device that has a plug with only two blades 215 and no grounding pin. This allows the plug to be placed into housing 220 without regard to any grounding pin. Additionally, the embodiment described in FIG. 2 and FIG. 3 could be offered as an “after market” device, suitable for use with any type of electrical device where the user wishes to reduce or eliminate the phantom load normally associated with an electrical device operating in standby mode.

Referring now to FIG. 4 a side view of an apparatus for energy conservation in an engaged position in accordance with an alternative preferred embodiment of the present invention is depicted. As shown in FIG. 4, this embodiment of the present invention comprises a unitary housing and plug combination. In this embodiment, plug portion 410 is permanently yet movably housed within housing 420 and blades 415 are extended through housing 420 to engage the electrical circuit housed within wall outlet 100, thereby energizing whatever electrical device is connected to plug portion 410. Additionally, the device could be distributed by electrical utility companies in an effort to reduce the consumption of electrical power for consumers.

Referring now to FIG. 5 a side view of an apparatus for energy conservation in a disengaged position in accordance with an alternative preferred embodiment of the present invention. As shown in FIG. 5, blades 415 are not permanently connected to plug portion 410 and moving plug portion 410 away from outlet 110 will disengage plug portion from blades 415, thereby eliminating the electrical connection between wall outlet 110 and plug portion 410, along with the electrical device that is connected to plug portion 410.

Referring now to FIG. 6 and FIG. 7, an alternative preferred embodiment of the apparatus described in FIG. 4 and FIG. 5 is depicted. This embodiment is substantially the same as the embodiment of FIG. 4 and FIG. 5 with the exception of the grounding pin depicted in FIG. 6 and FIG. 7. Those skilled in the art will recognize that the apparatus of FIG. 4, FIG. 5, FIG. 6 and FIG. 7, could be incorporated in electrical devices by the original equipment manufacturer and offered to consumers as energy saving devices.

It should be noted that the plug/housing combination depicted in FIG. 4, FIG. 5, FIG. 6 and FIG. 7 could further comprise a spring-loaded mechanism within the housing that would allow plug portion 510 to be moved from a first position to a second position within the housing by pressing on the distal end of plug portions 410 or 510 (e.g., the same type of mechanism used to extend and retract the writing portion of a pen into and out of the pen body or housing).

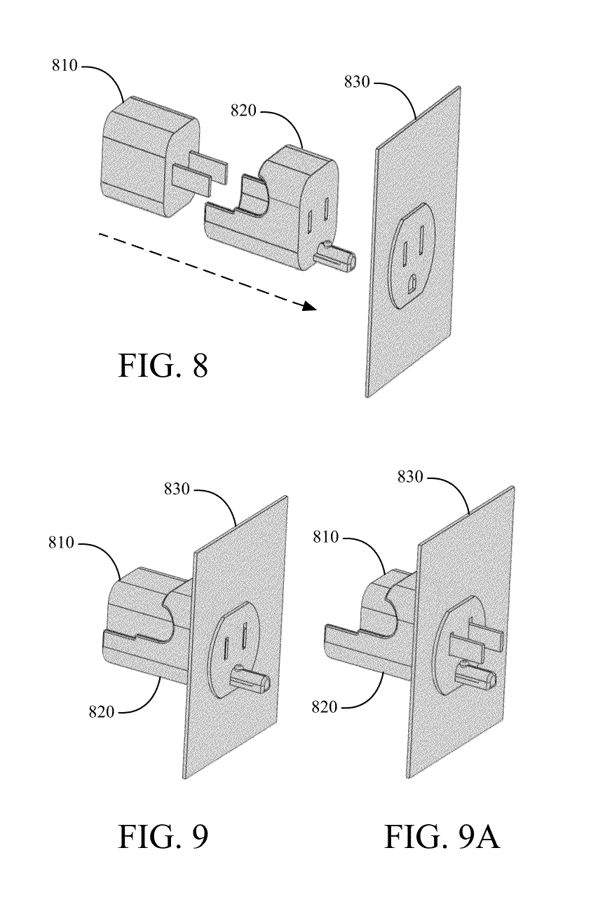

Referring now to FIG. 8 is a perspective view of the method of deployment for an apparatus for energy conservation in accordance with an alternative preferred embodiment of the present invention is depicted. As shown in FIG. 8, a plug 810 can be removably inserted into housing 820 and housing 820 can be inserted into and through the openings in wall outlet 830.

Referring now to FIG. 9, a perspective view of an apparatus for energy conservation in a disengaged position in accordance with an alternative preferred embodiment of the present invention is depicted. As shown in FIG. 9, plug 810 is now positioned within housing 820 and the support pin of housing 820 has been inserted into the opening in wall outlet 830 that is normally used for a grounding pin.

Since plug 820 does not have a grounding pin, the opening is available for use in conjunction with the present invention. In this position, the conductive blades of plug 810 are not yet extended through housing 820 and, accordingly, have not yet engaged the electrical circuit associated with wall outlet 830.

Referring now to FIG. 9A, a perspective view of an apparatus for energy conservation in an engaged position in accordance with an alternative preferred embodiment of the present invention is depicted. As shown in FIG. 9A, the blades of plug 810 have now been extended through housing 820, thereby allowing the blades to engage the electrical circuit associated with wall outlet 830.

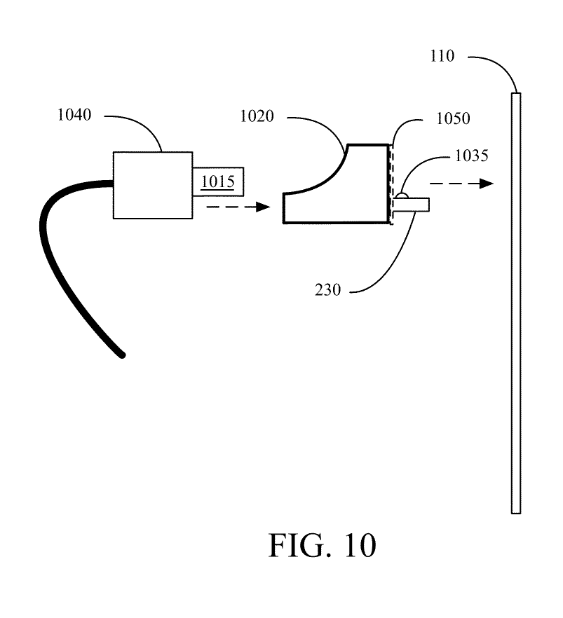

Referring now to FIG. 10, a side view of an apparatus for energy conservation in a disengaged position in accordance with an alternative preferred embodiment of the present invention is depicted. As shown in FIG. 10, a plug 1040 with conductive blades 1015 is positioned for insertion into housing 1020 and housing 1020 is positioned for insertion into wall outlet 110. In this embodiment of the present invention, support pin 230 further comprises a “button” or protrusion 1035. Protrusion 1035 is configured to increase the frictional fit of support pin 230 in the ground pin receptacle of wall outlet 110, further anchoring housing 1020 to wall outlet 110. Additionally, in this embodiment, an adhesive patch 1050 has been affixed to the front portion of housing 1020. Adhesive patch 1050 most preferably comprises a relatively aggressive yet removable adhesive compound applied to both surfaces of a resilient or cushioned flat and rectangular carrier (similar to the 3M® Command Strip®).

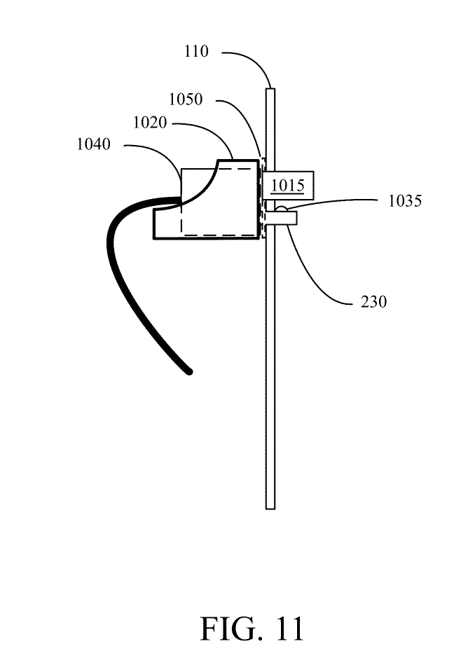

Referring now to FIG. 11, a side view of an apparatus for energy conservation in an engaged position in accordance with an alternative preferred embodiment of the present invention is depicted. As shown in FIG. 11, plug 1040 has been moved to a second position and blades 1015 are now extended through housing 1020 where conductive blades 1015 can engage the electrical circuit associated with wall outlet 110. Adhesive patch 1050 has been “sandwiched” between housing 1020 and the cover plate for wall outlet 110, thereby attaching housing 1020 to wall outlet 110.

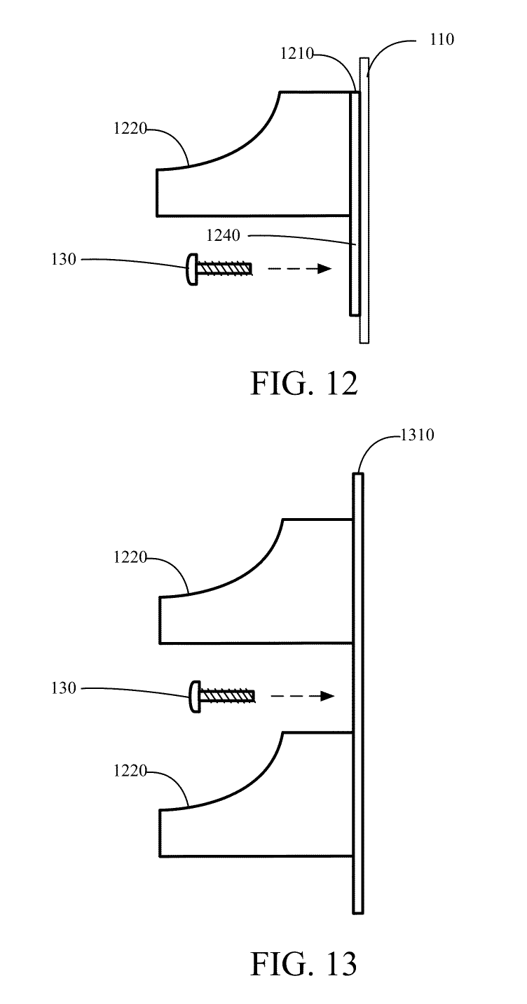

Referring now to FIG. 12, a side view of an alternative preferred embodiment of the present invention is depicted. As shown in FIG. 12, housing 1220 has an extended surface portion 1240 that is an integral part of housing 1120. Extended surface portion 1240 further comprises an aperture for receiving screw 130. Once screw 130 has been removed from the cover of wall outlet 110, housing 1220 can be positioned over wall outlet 110. Screw 130 is then inserted through the aperture in extended surface portion 1240 to engage the internal threads in wall outlet 110. This will removably secure housing 1220 to wall outlet 110 and any plug may be used in conjunction with housing 1220 in a like manner as previously described.

Referring now to FIG. 13, a side view of an alternative preferred embodiment of the present invention is depicted. Similar to the embodiment of FIG. 12, apparatus 1310 is configured to be removably affixed to a wall outlet. However, in this embodiment, the cover for wall outlet 110 is discarded and apparatus 1310 with dual housings 1220 are used to cover wall outlet 110. It should be noted that the embodiments of FIG. 12 and FIG. 13 will accept both 2 prong and 3 prong plugs.

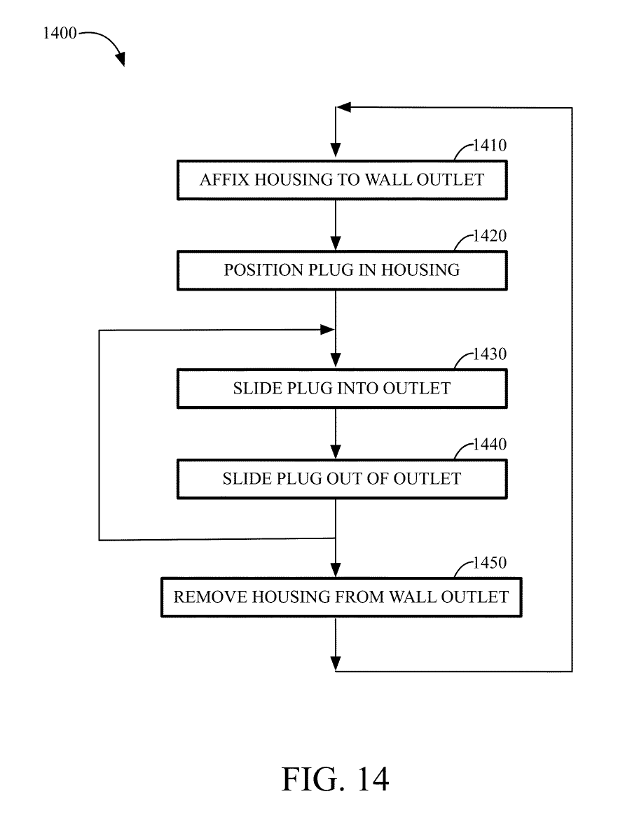

Referring now to FIG. 14, a flow chart of a method for using an apparatus for energy conservation in accordance with a preferred embodiment of the present invention is depicted. As shown in FIG. 14, a housing is affixed to a wall outlet (step 1410) and a plug is positioned with the housing (step 1420). Depending on the user requirements, the plug can be moved within the housing to selectively engage an electrical circuit associated with the wall outlet. The plug can be repeatedly slid forward (towards the wall outlet) to engage the electrical circuit associated with the outlet (step 1430) or slid backward (away from the wall outlet) to disengage the electrical circuit associated with the outlet (step 1440). When desired, the housing can be removed from the wall outlet (step 1450).

Those skilled in the art will recognize that the apparatus of FIG. 4, FIG. 5, FIG. 6, and FIG. 7 could be readily adapted for use with many electrical devices, including kitchen appliances, MP3 players, televisions, etc. In this preferred embodiment of the present invention, the electrical device would be manufactured and distributed by the original equipment manufacturer with an electrical cord that incorporates the housing and electrical plug of the present invention.

As previously described, the electrical plug comprises a plurality of electrically conductive blades and the plug is repositionable within the housing. When the housing is attached to an electrical outlet, the plug can be quickly and easily repositioned within the housing. With the plug positioned in a first position within the housing, an electrical contact is established between the conductive blades of the plug and the electrical circuitry housed within the electrical outlet, thereby providing electricity to the electrical devices. With the plug positioned in a second position, the electrical connection between the conductive blades of the plug and the electrical circuitry housed within the electrical outlet is eliminated, thereby preventing the flow of electricity to the electrical device. This will also serve the purpose of eliminating the phantom load effect of having the electrical device plugged directly into the wall outlet when the electrical device is operating in standby mode.

While the present invention has been shown and described with reference to preferred exemplary embodiments thereof, it will be understood by those skilled in the art that various changes in form and details may be made therein without departing from the spirit and scope of the invention. For example, the various embodiments of the present invention may be readily adapted to any style and type of electrical plug (e.g., square or round, 2-prong, 3-prong, etc.). Furthermore, while multiple embodiments have been presented in the foregoing description, it should be appreciated that a vast number of variations in the embodiments exist.

Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing one or more preferred exemplary embodiments of the present invention, it being understood that various changes may be made in the function and arrangement of elements described in the exemplary preferred embodiment without departing from the spirit and scope of the invention as set forth in the appended claims.

1. An apparatus comprising:
a first housing, the first housing being configured to attachment to an electrical outlet;
a plug contained at least partially within the first housing, the plug comprising a plurality of conductive blades; and
wherein the plug is configured to be moved from a first position within the first housing to a second position within the first housing, thereby selectively connecting the plurality of conductive blades with an electrical circuit associated with the electrical outlet.

2. The apparatus of claim 1 wherein the plug is configured to be moved from the second position within the first housing to the first position within the first housing, thereby selectively disconnecting the plurality of conductive blades from the electrical circuit associated with the electrical outlet.

3. The apparatus of claim 1 further comprising a non-conductive support rod affixed to and extending from the first housing, the support rod being configured to be removably inserted into an aperture in the electrical outlet, thereby attaching the housing to the electrical outlet.

4. The apparatus of claim 1 further comprising an adhesive patch positioned between the first housing and the electrical outlet.

5. The apparatus of claim 1 further comprising:
a non-conductive support rod affixed to and extending from the first housing, the support rod being configured to be removably inserted into an aperture in the electrical outlet, thereby attaching the housing to the electrical outlet; and
an adhesive patch positioned between the first housing and the electrical outlet.

6. The apparatus of claim 1 further comprising:
a second housing;
a plug contained at least partially within the second housing, the plug comprising a plurality of conductive blades; and
wherein the plug is configured to be moved from a first position within the second housing to a second position within the second housing, thereby selectively connecting the plurality of conductive blades with an electrical circuit associated with the electrical outlet.

7. The apparatus of claim 1 further comprising a screw inserted through an extended surface portion of the first housing, the screw engaging a threaded aperture contained within the electrical outlet.

8. A method comprising the steps of:
affixing at least a first housing to an electrical outlet;
positioning a plug in the first housing, the plug comprising a plurality of conductive blades;
moving the plug from a first position within the at least a first housing to a second position within the at least a first housing thereby selectively connecting the plurality of conductive blades with an electrical circuit associated with the electrical outlet.

9. The method of claim 7 further comprising the step of moving the plug from second position within the at least a first housing to the first position within the at least a first housing thereby selectively disconnecting the plurality of conductive blades from the electrical circuit associated with the electrical outlet.

10. The method of claim 7 wherein the step of affixing the at least a first housing to an electrical outlet comprises the steps of:
inserting a screw through an extended surface portion of the at least a first housing to affix the housing to an electrical outlet; and
tightening the screw into a threaded aperture contained within the electrical outlet.

11. The method of claim 7 wherein the step of affixing at least a first housing to an electrical outlet comprises the step of using an adhesive patch to affix the at least a first housing to an electrical outlet.

12. The method of claim 7 wherein the step of affixing the at least a first housing to an electrical outlet comprises the step of inserting a non-conductive support rod into an aperture in the electrical outlet.

13. The method of claim 7 further comprising the step of removing the at least a first housing from the electrical outlet.

14. An apparatus comprising:
an electrical device;
an electrical cord electrically connected to the electrical device;
a housing connected to the electrical cord, the housing containing an electrical plug, the electrical plug comprising a plurality of electrically conductive blades, the electrical plug being repositionable within the housing, the housing being attached to an electrical outlet; and
wherein the electrical plug is configured to be moved from a first position within the housing to a second position within the housing, thereby selectively connecting the plurality of conductive blades with an electrical circuit associated with the electrical outlet; and
wherein the electrical plug is configured to be moved from the second position within the housing to the first position within the housing, thereby selectively disconnecting the plurality of conductive blades from the electrical circuit associated with the electrical outlet and preventing the flow of electricity from the electrical circuit associated with the electrical outlet.

15. The apparatus of claim 14 wherein the electrical device comprises at least one of a kitchen appliance, an MP3 player, and a television.
